(19) United States
(12) Patent Application Publication
(10) Pub. No.: US 2024/0370515 A1
(43) Pub. Date: Nov. 7, 2024

(54) GENERATING INTERACTIVE SCREENSHOTS USING A FEDERATED NETWORK

(71) Applicant: Pager Technologies, Inc., Brooklyn, NY (US)

(72) Inventors: Alexander Mahedy, New York, NY (US); Duncan Buck, Berlin (DE)

(21) Appl. No.: 18/310,991

(22) Filed: May 2, 2023

(51) Int. Cl. G06F 16/955; G06F 16/951; G06F 16/958

(52) U.S. Cl. CPC G06F 16/9558; G06F 16/951; G06F 16/958

(57) ABSTRACT

Aspects of the disclosure provide for mechanisms for generating interactive screenshot based on a screenshot. A method of the disclosure includes retrieving a screenshot by a first computing device of a plurality of computing devices, identifying a subset of the plurality of computing devices, transmitting a unique packet of data associated with the screenshot for each of the subset of the plurality of computing devices, obtaining an intermediate result used to generate an interactive screenshot based on the unique packet of data, and generating the interactive screenshot based on the intermediate results of each of the subset of the plurality of computing devices.

### TECHNICAL FIELD

Embodiments of the disclosure relate generally to memory sub-systems, and more specifically, relate to generating interactive screenshots using a federated network of computing devices.

### BACKGROUND

Content sharing (e.g., articles, restaurants, shows, songs, videos, social media posts) is typically performed through Uniform Resource Locator (URL) sharing or screenshot sharing of the content.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a block diagram of an example computing device used to generate an interactive screenshot, in accordance with some embodiments of the present disclosure.

FIG. 2 illustrates an exemplary illustration of a federated network used to generate an interactive screenshot, in accordance with some embodiments of the present disclosure.

FIG. 3 is an exemplary illustration of a federated network used to generate an interactive screenshot, in accordance with some embodiment of the present disclosure.

FIG. 4 is a flow diagram of an example method for generating interactive screenshots using the federated network, in accordance with some embodiments of the present disclosure.

FIG. 5 is a flow diagram of an example method for generating interactive screenshots using the federated network, in accordance with some embodiments of the present disclosure.

FIG. 6 is a flow diagram of an example method for generating interactive screenshot, in accordance with some embodiments of the present disclosure.

FIG. 7 is a block diagram of an example computer system in which embodiments of the present disclosure may operate.

### DETAILED DESCRIPTION

Aspects of the present disclosure are directed to a federated network of computing devices used to generate interactive screenshots based on static screenshots. Screenshots can be static digital images that capture the display's contents (e.g., a computer device, mobile device, etc.). Screenshots are created by the operating system or software running on the computer or mobile device, for example. In general, screenshots can be utilized to share the contents of the display with other computer devices or mobile devices. Content sharing can be performed through a URL (e.g., link), which provides the receiver with a link to the content or the specific location of the web-based application where the content is located. However, with no image, the receiver has no immediate reference to the purpose or intention behind the URL. In some embodiments, the URL may be shared with an auto-populated snapshot of the content during sharing of the URL. However, in these instances, the snapshot of the content is directed to the content as a whole rather than a specific portion that may have been of interest to the receiver.

Content sharing can be done by sharing a screenshot that provides an image reflecting the content, however the receiver cannot immediately access the content. While the intent and purpose of the content can be actualized from the screenshot by the receiver, the receiver is left without means to interact with the content, manually search the Internet or other applications to interact with the content, or forgoing access to the content. Further, in some embodiments, the sender of the screenshot or user who screenshotted the content may lose track of a location (e.g., the URL or application) that corresponds to the content, in which case the user, receiver, and/or sender would have to scrape the Internet and other applications manually to find the content to interact with it directly.

Aspects of the present disclosure address the above and other deficiencies by having a federated network of computing devices (and, in some instances, servers) combine a static screenshot of content with a link and/or an applet to generate an interactive screenshot (or experience). One or more computing devices of the federated network (further referred to as federated network) identify an application within the static screenshot. Based on the identified application, the federated network extracts information from the static screenshot. Based on the identified application and extracted information from the static screenshot, the federated network performs a query search to generate a URL corresponding to the static screenshot as a whole and/or each portion (or sub-portion) of the static screenshot. Based on the generated URL, the federated network updates the static screenshot as a whole and/or the relevant portions of the static screenshot with the URL (or data derived from the URL) to generate an interactive screenshot.

Advantages of the present disclosure include, but are not limited to, reducing the reliance on a server to generate interactive screenshots, thereby providing a decentralized approach to generating interactive screenshots. Various aspects of the above-referenced methods and systems are described in detail below by examples, rather than by limitations.

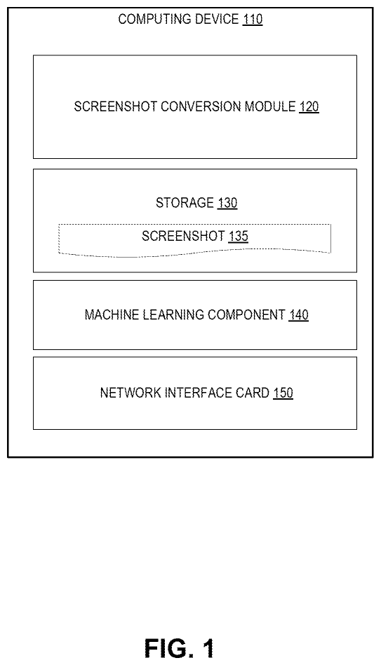

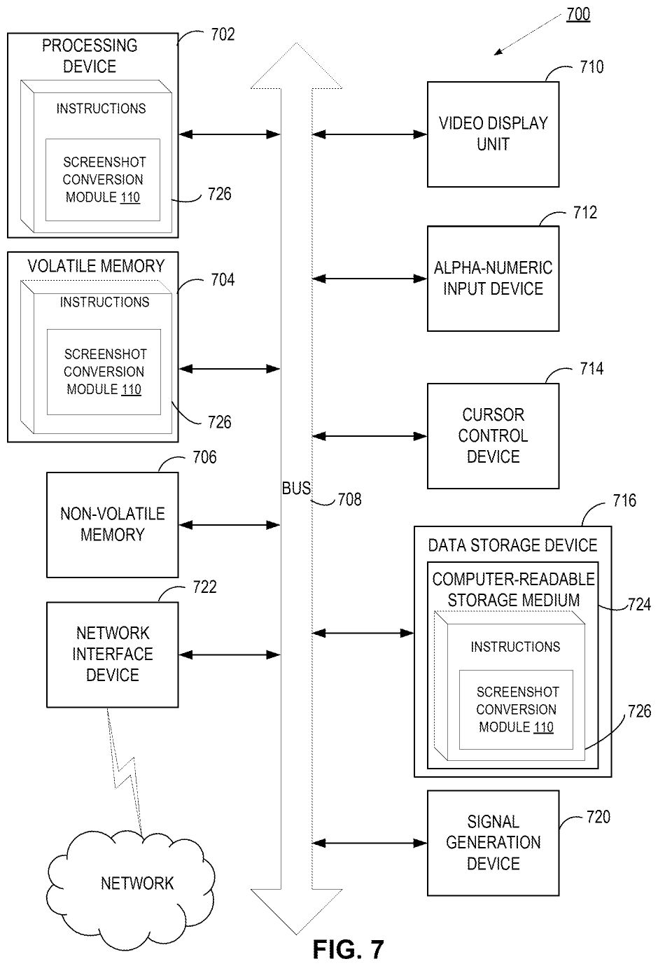

FIG. 1 illustrates a computing device 110 in which implementation of the disclosure may operate. Computing device 110 may be a desktop computer, a laptop computer, a smartphone, a tablet computer, a server, a scanner, or any suitable computing device capable of performing the techniques described herein. Computing device 110 includes a screenshot conversion module 120, a storage 130, a machine learning component 140, and a network interface card (NIC) 150. In some implementations, computing device 110 can be (and/or include) one or more computing devices 700 of FIG. 7.

The screenshot conversion module 120 may generate an interactive screenshot from screenshot 135 stored in storage 130. The screenshot conversion module 120 uses image processing and/or machine learning to identify an application within screenshot 135. Contents are extracted from within the identified application within screenshot 135. The extracted contents are used to generate the interactive screenshot.

Screenshot 135 may be a visual representation of an application, an operating system, a document containing images, text, and/or URL links. The screenshot conversion module 120 retrieves screenshot 135 from a storage device. The storage device may be internal storage 130 or an external storage device (e.g., cloud). Screenshot 135 may include varying degrees of metadata. In some instances, the metadata of screenshot 135 may not be sufficient to determine which application was captured in the screenshot screenshotted.

In some embodiments, the screenshot conversion module 120 may identify an application in screenshot 135 by identifying structural elements (e.g., application markers) within screenshot 135. The screenshot conversion module 120 may use machine learning (e.g., convolution neural network (CNN), artificial neural network (ANN), deep neural network (DNN), etc.) to identify structural elements within a screenshot. Structural elements may include icons, buttons, titles, logos, or other suitable GUI elements. The application may be a social media application, a music application, a web page, a web browser, a messaging application, or any other third-party application.

The screenshot conversion module 120 may extract each structural element (e.g., application markers) of the identified application and content element (e.g., content marker) from within the identified application within screenshot 135. Content elements may include text, images, URLs, or any other suitable information associated with the application's contents. For example, for a social media application, the extracted content elements can include images, user name, comments, number of comments, duration of a video post, text, date, and time of the post.

The screenshot conversion module 120 may perform a query search for each extracted element and/or structural element to obtain an interactive element. In particular, the screenshot conversion module 120 may query, via local databases, external databases, and/or other searching techniques, to obtain links and/or applets for each extracted element and/or structural element. Searching techniques can include web-crawling (or web-scraping), an application programming interface (API) of the identified application, a software development kit (SDK) of the identified application, semantic text matching, reverse image searching, etc. Links may be an application programming interface (API), a digital object identifier (DOI), a uniform resource identifier (URI), a uniform resource locators (URL), etc. Applets may be small applications (or programs) with various functionality that resembles the functionality of an extracted element and/or a structural element. For example, an applet may be developed and stored in the local and/or external database to mimic the functionality of the extracted element and/or structural element or the applet may be a third-party applet associated with the identified application that provides the functionality to the extracted element and/or structural element.

In some embodiments, additional information from the computing device 110 may be used by the screenshot conversion module 120 to assist in identifying the application within the screenshot and/or performing the query search for extracted elements from the identified application. The additional information may include sensor data, application programming interface (API), location services, and data from internal memory, including installed applications, cache files, etc. For example, the screenshot conversion module 120 may access the internal memory to obtain a list of installed applications and determine whether the structural elements correspond to one of the installed applications. In another example, the screenshot conversion module 120 may access location services to identify an area that limits the query search of extracted elements. The area may be a radius area indicating a likely area in which the screenshot was taken. In another example, the screenshot conversion module 120 may access cache files associated with each installed application to limit the query search of extracted elements.

The screenshot conversion module 120 may update each element of screenshot 135 with the interactive element used to redirect, via a link, a user to a source of the content associated with the an element (e.g., extracted element and/or a structural element) or provide functionality, via an applet, corresponding to the content associated with the element (e.g., extracted element and/or a structural element) of screenshot 135. In some embodiments, providing functionality via the applet includes providing a graphical user interface as the interactive element which when interacted with reproduces the functionality of the element.

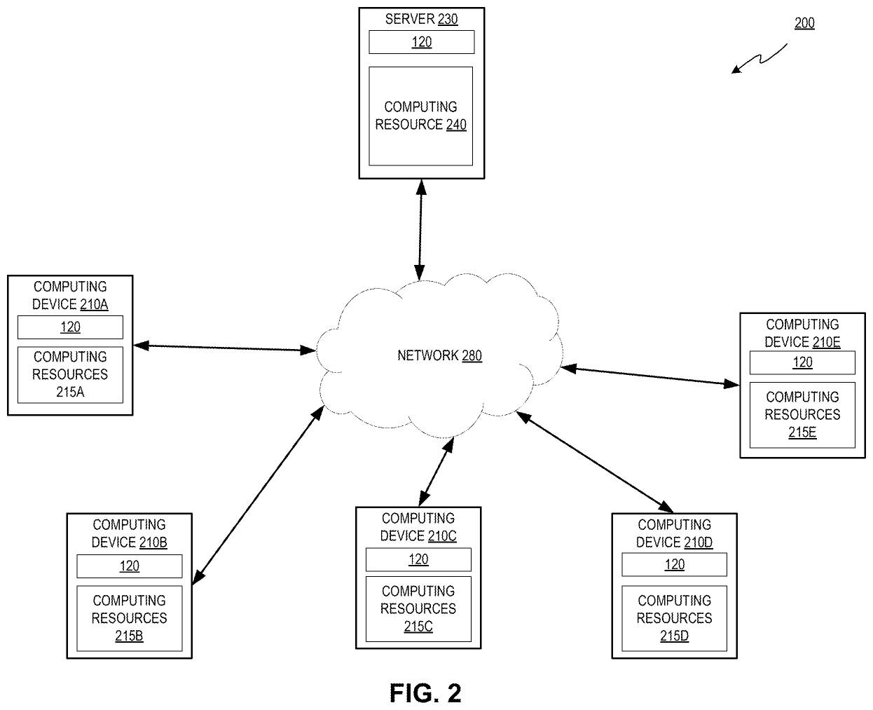

FIG. 2 illustrates a federated network 200 that includes server 230 and computing devices 210A-E, similar to the computing device 110 of FIG. 1. Server 230 and each of the computing devices 210A-E is interconnected to one another via a peer-to-peer (P2P) network. In some instances, the server and each of the computing devices 210A-E may be interconnected to one another via a network 280. Network 280 may be a public network (e.g., Internet), a private network (e.g., a local area network (LAN) or wide area network (WAN)), or a combination thereof.

Server 230 and each of the computing devices 210A-E, similar to computing device 110 of FIG. 1, includes a screenshot conversion module 120. One of the computing devices 210A-E (e.g., originating device) may retrieve a screenshot to generate an interactive screenshot. The originating computing device (e.g., computing device 210A) may rely on the federated network 200 to generate the interactive screenshot.

In some embodiments, the originating computing device may provide the screenshot to the screenshot conversion module 120 of server 230 to generate the interactive screenshot. Accordingly, Server 230 may identify the application within the screenshot, extract elements from within the identified application, perform a query search on the extracted elements, and generate an interactive screenshot based on the query search results.

In another embodiment, the screenshot conversion module 120 of the originating computing device may identify the application within the screenshot and extract elements from within the identified application. The originating computing device may provide the extracted elements to the screenshot conversion module 120 of server 230 configured to perform query searches. Accordingly, Server 230 may return a link or applet for each extracted element from the originating computing device. The screenshot conversion module 120 of the originating computing device receives the link or applet and generates an interactive screenshot based on the received links or applets.

Regardless of the approach, server 230 may identify the amount of computational power necessary to fulfill the request of the originating computing device. Server 230 may request computing resources from a subset of the computing devices 210A-E. In some embodiments, the server may request computing resources from all of the computing devices 210A-E. Each of the requested computing devices may provide their available computing resources (e.g., computing resource 215B of computing device 210B) to server 230.

In some embodiments, each computing device that provided computing resources may be compensated. Compensation may be in digital currency (e.g., cryptocurrency, tokens), fiat currency, complimentary use of the screenshot conversion module, etc.

Server 230, using the received computing resources of the requested computing devices, may proceed with fulfilling the request of the originating computing device. Depending on the embodiment, server 230 may request computing resources from the computing devices 210A-E in anticipation of a request from the computing devices 210A-E.

Depending on the embodiment, server 230 may be a mobile web server instantiated within the originating computing device. Accordingly, the originating computing device or server 230 may identify an amount of computational power necessary to fulfill the demands of the originating computing device. The originating computing device and/or server 230 may request and receive computing resources from the remaining computing devices (e.g., computing devices 210B-E). Server 230, using the received computing resources of the requested computing devices, may fulfill the demands of the originating computing device instead of the originating computing device.

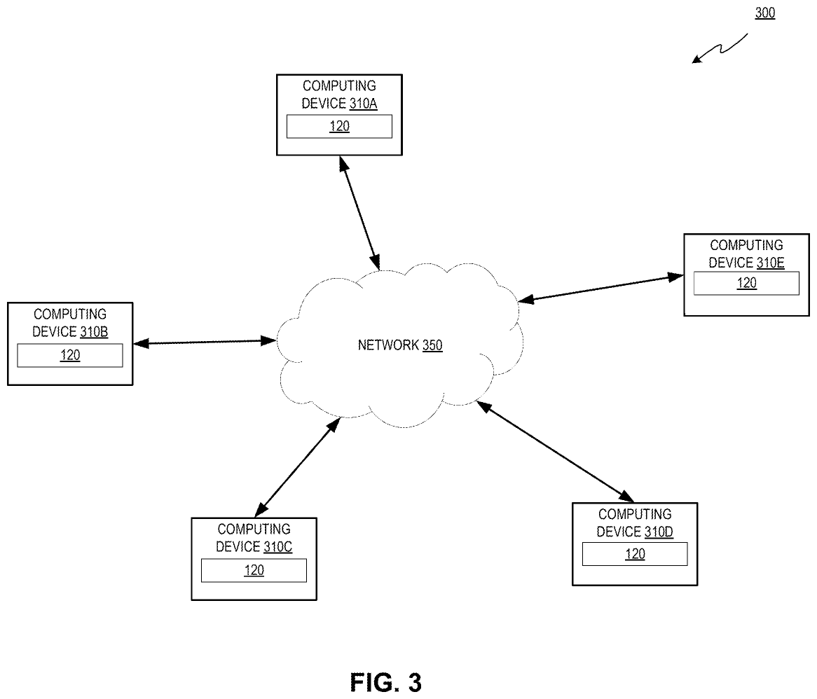

FIG. 3 illustrates a federated network 300 that includes computing devices 310A-E, similar to the computing device 110 of FIG. 1. Each of the computing devices 310A-E is interconnected to one another via a peer-to-peer (P2P) network. In some instances, each of the computing devices 310A-E may be interconnected to one another via a network 380. Network 380 may be a public network (e.g., Internet), a private network (e.g., a local area network (LAN) or wide area network (WAN)), or a combination thereof.

Each of the computing devices 310A-E, similar to computing device 110 of FIG. 1, includes a screenshot conversion module 120. One of the computing devices 310A-E (e.g., originating device), may retrieve a screenshot to generate an interactive screenshot. The originating computing device (e.g., computing device 210A) may rely on the federated network 300 to generate the interactive screenshot.

The originating computing device may provide the screenshot conversion module 120 of the remaining computing devices (e.g., computing devices 210B-F) a packet of data. In some embodiments, only a subset of the remaining computing devices may be designated to receive the packet of data to process. The packet of data may be a screenshot (or a portion of the screenshot) retrieved by the originating computing device and/or an intermediate result of a screenshot conversion module. The intermediate result of the screenshot conversion module may include structural elements of the screenshot, content elements of the screenshot, link and/or applet, query search results, etc. The intermediate results of the screenshot conversion module may be any information produced by one or more steps of the screenshot conversion module.

Depending on the embodiment, the originating computing device may instruct each of the remaining computing devices to process the packet of data similarly. In an example, each of the remaining computing devices, using the received packet of data (e.g., a screenshot), performs all the steps necessary to generate an interactive screenshot. As noted above, the steps to generate the interactive screenshot may include identifying the application within the screenshot, extracting elements from the identified application, obtaining links and/or applets for extracted elements, and generating the interactive screenshot using the obtained links and/or applets. In another example, each of the remaining computing devices, using the received packet of data (e.g., extracted elements), performs a specific step (e.g., obtaining links and/or applets for the extracted elements).

In an embodiment, the remaining computing devices may reach a consensus as to which result of the remaining computing devices will be provided to the originating computing device. The remaining computing devices may reach a consensus using any suitable consensus mechanism that allows a network (e.g., federated network 200) to agree on the state of the results. Some examples of consensus mechanisms may be proof of stake, delegated proof of stake, proof of work, proof of elapsed time, proof of activity, etc.

In another embodiment, the originating computing device may receive the results (e.g., the interactive screenshot, the obtained links and/or applets, etc.) from each of the remaining computing devices and identify the most accurate result. In some embodiments, the originating computing device may identify the most accurate result based on a confidence score (or trust score) assigned to each of the remaining computing devices. Accordingly, the result associated with the computing device among the remaining computing device with the highest confidence score will be accepted as the most accurate result (or true result). The confidence score of each of the remaining computing devices may be assigned and updated based on a user's input regarding the accuracy of the results. For example, the user of the originating device may identify whether one or more obtained links redirected the user to the appropriate location within the identified application, whether the identified application was correct, etc. Other methods of assessing the accuracy of the remaining computing devices to process the packet of data are contemplated. Depending on the embodiment, the most accurate result may be manually selected.

Depending on the embodiment, the originating computing device instructs each remaining computing device to process a unique packet of data. In an example, each of the remaining computing devices, using the received packet of data (e.g., a different portion of the screenshot), performs all the steps necessary to generate an interactive screenshot. In particular, the steps include identifying the application based on the portion of the screenshot, extracting elements from the portion of the identified application, obtaining links and/or applets for extracted elements, and generating a portion of the interactive screenshot using the obtained links and/or applets. The originating computing device may combine the individual portions of the interactive screenshot into a cohesive interactive screenshot or provide the individual portions of the interactive screenshot as a packet of data to another one of the remaining computing devices to combine.

In another example, each of the remaining computing devices receives a packet of data necessary to perform a specific step. In particular, a remaining computing device may receive structural elements to perform the step of identifying the application, another remaining computing device may receive the identified application to perform the step of extracting elements from the identified application, and so on.

Each result generated by a remaining computing device may be forwarded to the originating computing device to determine whether the originating computing device or another one of the remaining computing devices will perform the next step in generating the interactive screenshot. Based on the determination, the originating computing device will either perform the next step or send a packet of data necessary to perform the next step to another remaining device. The originating computing device continues until the interactive screenshot is generated. The generated interactive screenshot is then provided to the originating computing device. Depending on the computing device that generated the interactive screenshot, the generated interactive screenshot is then provided to the originating computing device.

Alternatively, each remaining computing device may forward their respective results to another one of the remaining computing devices to perform the next step in generating the interactive screenshot. The results are constantly forwarded to another one of the remaining computing devices until the interactive screenshot is generated. Depending on the computing device that generated the interactive screenshot, the generated interactive screenshot is then provided to the originating computing device.

Each computing device that was instructed to process a packet of data may be compensated. Compensation may be in digital currency (e.g., cryptocurrency, tokens), fiat currency, complimentary use of the screenshot conversion module, etc.

It should be noted that while different approaches with respect to the federated network 200 and 300, any combination of approaches may be utilized to generate an interactive screenshot.

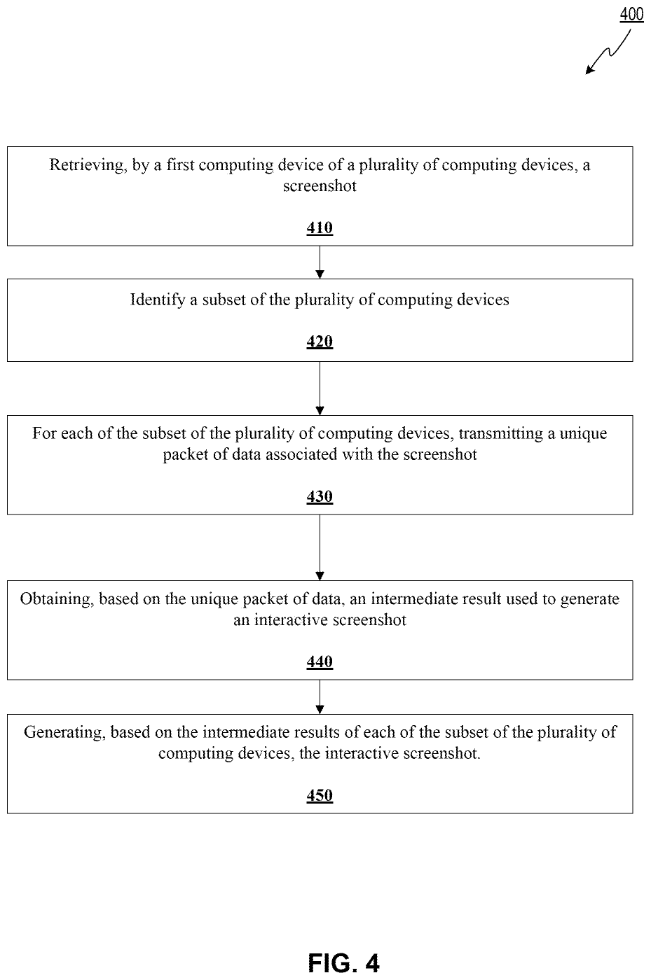

FIG. 4 is a flow diagram of an example method 400 of generating interactive screenshots using the federated network in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the screenshot conversion module 120 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic retrieves, by a first computing device of a plurality of computing devices, a screenshot. The screenshot may be stored in a local storage of the first computing device or an external storage device.

At operation 420, the processing logic identifies a subset of the plurality of computing devices. As previously described, the subset of the plurality of computing devices may be the remaining computing devices or any combination of the plurality of computing devices.

At operation 430, for each of the subset of the plurality of computing devices, the processing logic transmits a unique packet of data associated with the screenshot. The packet of data may be structural elements of the screenshot, an identified application within the screenshot, extracted elements from the identified application within the screenshot, or links and/or applets associated with the extracted element. Each of the subset of the plurality of computing devices gets a unique or different packet of data. In some embodiments, the packet of data may be a portion of the screenshot. Each of the subset of the plurality of computing devices gets a unique or different portion of the screenshot (packet of data).

At operation 440, the processing logic obtains, based on the unique packet of data, an intermediate result used to generate an interactive screenshot. The intermediate result may be an identified application, extracted elements, links and/or applets, or interactive elements. The intermediate results are obtained by processing, using the screenshot conversion module, the unique packet of data and arriving at the intermediate result. Depending on the embodiment, if the packet of data is a portion of the screenshot, the intermediate result that is returned from the screenshot conversion module is the portion of the screenshot with interactive elements.

At operation 450, the processing logic generates, based on the intermediate result, the interactive screenshot. The individual intermediate result (e.g., link and/or applet associated with the extracted element) is used to generate interactive elements and update the screenshot to the interactive screenshot. In other instances, the individual intermediate result (e.g., a portion of the screenshot with interactive elements) are combined with other individual intermediate results to generate the full interactive screenshot.

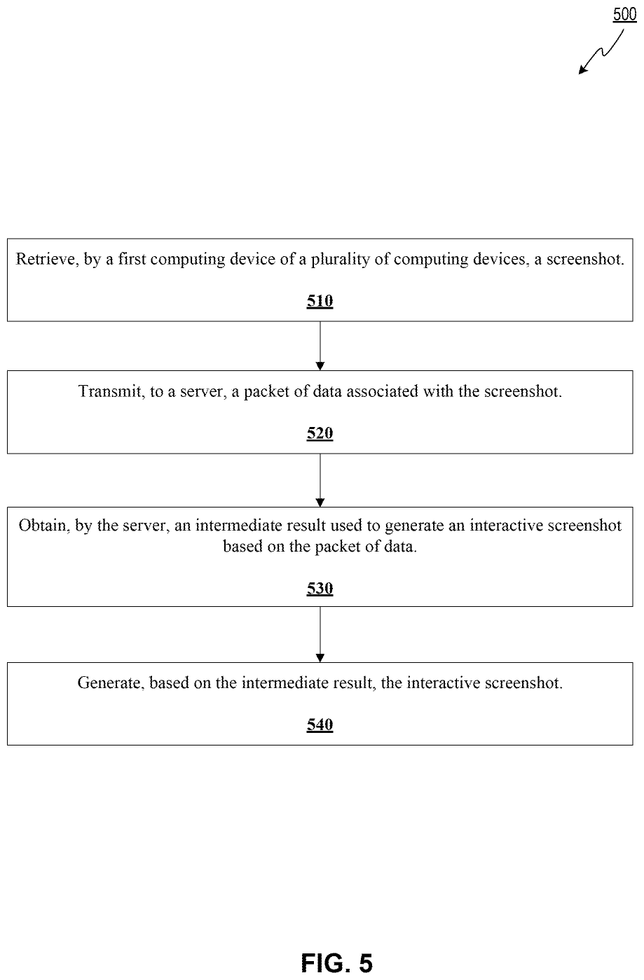

FIG. 5 is a flow diagram of an example method 500 of generating interactive screenshots using the federated network in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the screenshot conversion module 120 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic retrieves, by a first computing device of a plurality of computing devices, a screenshot. The screenshot may be stored in a local storage of the first computing device or an external storage device.

At operation 520, the processing logic transmits, to a server, a packet of data associated with the screenshot. The packet of data may be structural elements of the screenshot, an identified application within the screenshot, extracted elements from the identified application within the screenshot, or a link and/or applet associated with the extracted element. In some embodiments, the packet of data may be a portion of the screenshot.

The server is based on computing resources allocated by a subset of the plurality of computing devices. As previously described, the server request computing resources from the subset of the computing devices. Each of the requested computing devices provides its available computing resources to the server. The server, using the received computing resources of the requested computing devices, fulfills the request of the first computing device. As previously described, the subset of the plurality of computing devices may be the remaining computing devices or any combination of the plurality of computing devices.

At operation 530, the processing logic obtains, by the server, an intermediate result used to generate an interactive screenshot based on the packet of data. The intermediate result may be an identified application, extracted elements, links and/or applets, or interactive elements. The intermediate results are obtained by processing, using the screenshot conversion module, the unique packet of data and arriving at the intermediate result. Depending on the embodiment, if the packet of data is a portion of the screenshot, the intermediate result that is returned from the screenshot conversion module is the portion of the screenshot with interactive elements.

At operation 540, the processing logic generates, based on the intermediate result, the interactive screenshot. The individual intermediate result (e.g., link and/or applet associated with the extracted element) is used to generate interactive elements and update the screenshot to the interactive screenshot. In other instances, the individual intermediate result (e.g., a portion of the screenshot with interactive elements) is combined with other individual intermediate results to generate the full interactive screenshot.

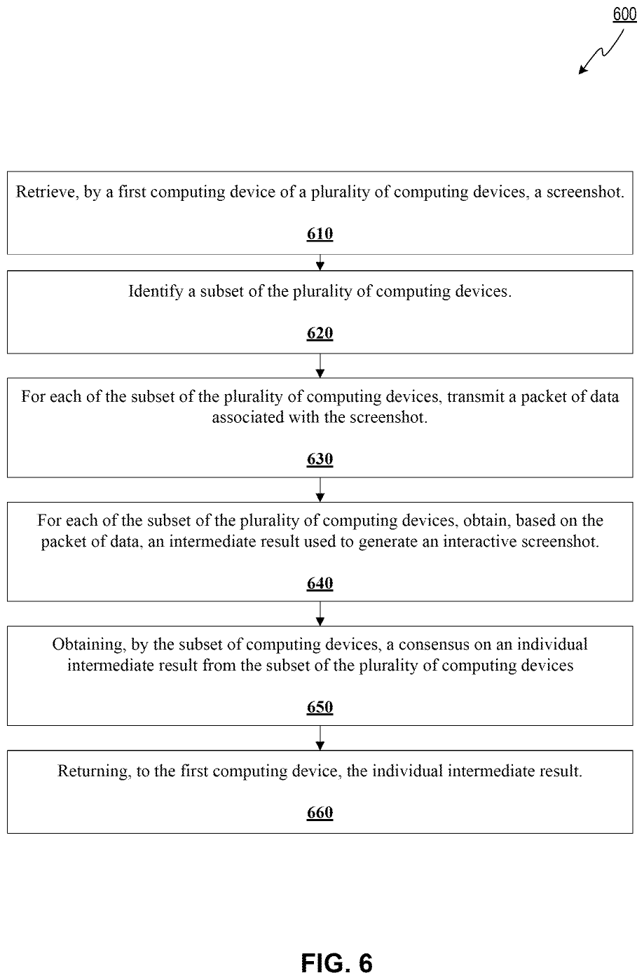

FIG. 6 is a flow diagram of an example method 600 of generating interactive screenshots using the federated network, in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the screenshot conversion module 120 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 610, the processing logic retrieves, by a first computing device of a plurality of computing devices, a screenshot. The screenshot may be stored in a local storage of the first computing device or an external storage device.

At operation 620, the processing logic identifies a subset of the plurality of computing devices. As previously described, the subset of the plurality of computing devices may be the remaining computing devices or any combination of the plurality of computing devices.

At operation 630, for each of the subset of the plurality of computing devices, the processing logic transmits a packet of data associated with the screenshot. The packet of data may be structural elements of the screenshot, an identified application within the screenshot, extracted elements from the identified application within the screenshot, or a link and/or applet associated with the extracted element. Each of the subset of the plurality of computing devices gets the same packet of data. In some embodiments, the packet of data may be a portion of the screenshot. Each of the subset of the plurality of computing devices gets the same portion of the screenshot (packet of data).

At operation 640, for each of the subset of the plurality of computing devices, the processing logic obtains, based on the packet of data, an intermediate result used to generate an interactive screenshot. The intermediate result may be an identified application, extracted elements, links and/or applets, or interactive elements. The intermediate results are obtained by processing, using the screenshot conversion module, the unique packet of data and arriving at the intermediate result. Depending on the embodiment, if the packet of data is a portion of the screenshot, the intermediate result returned from the screenshot conversion module is the portion of the screenshot with interactive elements.

At operation 650, the processing logic obtains, by the subset of computing devices, a consensus on an individual intermediate result from the subset of the plurality of computing devices. As previously described, consensus may be reached using any suitable consensus mechanism (e.g., proof of stake). At operation 660, the processing logic returns, to the first computing device, the individual intermediate result.

In some embodiments, the processing logic generates, based on the individual intermediate result, the interactive screenshot. The individual intermediate result (e.g., link and/or applet associated with the extracted element) is used to generate interactive elements and update the screenshot to the interactive screenshot. In other instances, the individual intermediate result (e.g., a portion of the screenshot with interactive elements) are combined with other individual intermediate results to generate the full interactive screenshot.

FIG. 7 depicts an example computer system 700 which can perform any one or more of the methods described herein. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 700 includes a processing device 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)), and a data storage device 716, which communicate with each other via a bus 708.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like. The processing device 702 is configured to execute instructions 726 for implementing the screenshot conversion module 120 of FIG. 1 and to perform the operations and steps discussed herein (e.g., methods 400 of FIG. 4, 500 of FIG. 5, and 600 of FIG. 6).

The computer system 700 may further include a network interface device 722. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 720 (e.g., a speaker). In one illustrative example, the video display unit 710, the alphanumeric input device 712, and the cursor control device 714 may be combined into a single component or device (e.g., an LCD touch screen).

The data storage device 716 may include a computer-readable storage medium 724 on which is stored the instructions 726 embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting computer-readable media. In some implementations, the instructions 726 may further be transmitted or received over a network via the network interface device 722.

While the computer-readable storage medium 724 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

1. A method comprising:
retrieving, by a first computing device of a plurality of computing devices, a screenshot;
identifying a subset of the plurality of computing devices;
for each of the subset of the plurality of computing devices, transmitting a portion of the screenshot;
obtaining, from each computing device of the subset and based on the portion of the screenshot, an intermediate result used to generate an interactive screenshot, wherein the intermediate result is obtained from performing one or more of: identifying an application within the screenshot, extracting elements from the identified application, or obtaining links associated with the extracted elements; and
generating, based on the intermediate results of each of the subset of the plurality of computing devices, the interactive screenshot.

2. The method of claim 1, wherein the screenshot may be stored in a local storage of the first computing device or an external storage device.

3. The method of claim 1, wherein the portion of the screenshot is one of: structural elements of the screenshot, an identified application within the screenshot, extracted elements from the identified application within the screenshot, link associated with the extracted element, or an applet associated with the extracted element.

4. The method of claim 1, wherein the intermediate result is one of: an identified application, extracted elements, links, applets, or interactive elements.

5. The method of claim 1, wherein the portion of the screenshot is a unique portion of the screenshot.

6. The method of claim 5, wherein the intermediate result is the unique portion of the screenshot with interactive elements.

7. A system comprising:
a memory; and
a processor, operatively coupled with memory, to perform operations comprising:
retrieving, by a first computing device of a plurality of computing devices, a screenshot;
transmitting, to a server, a portion of the screenshot;
obtaining, by the server, an intermediate result used to generate an interactive screenshot based on the portion of the screenshot, wherein the intermediate result is obtained from the server performing one or more of: identifying an application within the screenshot, extracting elements from the identified application, or obtaining links associated with the extracted elements; and
generating, based on the intermediate result, the interactive screenshot.

8. The system of claim 7, wherein the server is based on computing resources allocated by a subset of the plurality of computing devices.

9. The system of claim 7, wherein the screenshot may be stored in a local storage of the first computing device or an external storage device.

10. The system of claim 7, wherein the portion of the screenshot is one of: structural elements of the screenshot, an identified application within the screenshot, extracted elements from the identified application within the screenshot, link associated with the extracted element, or an applet associated with the extracted element.

11. The system of claim 7, wherein the intermediate result is one of: an identified application, extracted elements, links, applets, or interactive elements.

12. The system of claim 7, wherein the portion of the screenshot is a unique portion of the screenshot.

13. The system of claim 12, wherein the intermediate result is the portion of the screenshot with interactive elements.

14. A non-transitory computer-readable storage medium comprising instructions that, when executed by a processing device, cause the processing device to perform operations comprising:
retrieving, by a first computing device of a plurality of computing devices, a screenshot;
identifying a subset of the plurality of computing devices;
for each of the subset of the plurality of computing devices, transmitting a portion of the screenshot;
for each of the subset of the plurality of computing devices, obtaining, from a respective computing device and based on the portion of the screenshot, an intermediate result used to generate an interactive screenshot, wherein the intermediate result is obtained from the respective computing device performing one or more of: identifying an application within the screenshot, extracting elements from the identified application, or obtaining links associated with the extracted elements;
obtaining, by the subset of computing devices, a consensus on an individual intermediate result from the subset of the plurality of computing devices; and
returning, to the first computing device, the individual intermediate result.

15. The non-transitory computer-readable storage medium of claim 14, wherein the processing device is further caused to perform operations comprising:
generating, based on the individual intermediate result, the interactive screenshot.

16. The non-transitory computer-readable storage medium of claim 14, wherein the screenshot may be stored in a local storage of the first computing device or an external storage device.

17. The non-transitory computer-readable storage medium of claim 14, wherein the portion of the screenshot is one of: structural elements of the screenshot, an identified application within the screenshot, extracted elements from the identified application within the screenshot, link associated with the extracted element, or an applet associated with the extracted element.

18. The non-transitory computer-readable storage medium of claim 14, wherein the intermediate result is one of: an identified application, extracted elements, links, applets, or interactive elements.

19. The non-transitory computer-readable storage medium of claim 14, wherein the portion of the screenshot is a unique portion of the screenshot.

20. The non-transitory computer-readable storage medium of claim 19, wherein the intermediate result is the portion of the screenshot with interactive elements.
